(19) United States
(12) Patent Application Publication
(10) Pub. No.: US 2012/0288705 A1
(43) Pub. Date: Nov. 15, 2012

(54) HYDROXYAPATITE COATED METAL SURFACE AND METHOD FOR PRODUCING

(75) Inventors: PETER MILES ANSON SHERWOOD, Stillwater, OK (US); FENG GAO, Stillwater, OK (US)

(73) Assignee: THE BOARD OF REGENTS FOR OKLAHOMA STATE UNIVERSITY, Stillwater, OK (US)

(21) Appl. No.: 13/291,495

(22) Filed: Nov. 8, 2011

Related U.S. Application Data
(60) Provisional application No. 61/411,281, filed on Nov. 8, 2010.

(51) Int. Cl. B32B 15/04; B05D 3/06; B05D 3/10; B05D 7/14

(52) U.S. Cl. 428/332; 428/457; 427/327; 427/554; 427/309

(57) ABSTRACT

A device having a body with a metal surface having an oxide free portion. An oxide free phosphorus-containing layer is disposed on the metal surface, and a hydroxyapatite layer is on the phosphorus-containing layer.

### CROSS REFERENCE TO RELATED APPLICATIONS

This application claims the priority of U.S. Provisional Patent Application No. 61/411,281, entitled “COMPOSITION FOR HYDROXYAPATITE FILM AND METHOD FOR FORMING THE HYDROXYAPATITE FILM,” filed Nov. 8, 2010, the contents of which are hereby incorporated by reference.

### FIELD OF THE INVENTION

This disclosure relates to surface coating technology in general and, more particularly, to a system and method for applying hydroxyapatite to metals.

### BACKGROUND OF THE INVENTION

Due to its biocompatible nature, hydroxyapatite may be used to cover prostheses, and as a substitute for bone and teeth. Hydroxyapatite has the formula: Ca₁₀(PO₄)₆(OH)₂. Many substitutions are possible in the hydroxyapatite structure with Ca²⁺ being replaced by other M²⁺ ions and the orthophosphate ion being replaced by other XO₄ ions.

There is an ongoing need in the art for coatings on the surface of medical implants that have corrosion inhibition, adhesion promotion, and biocompatibility properties. Because hydroxyapatite is a key component of bone and teeth, metals coated with hydroxyapatite will have desirable biocompatible properties.

### SUMMARY OF THE INVENTION

The invention of the present disclosure, in one aspect thereof, comprises a device having a body with a metal surface having an oxide free portion. The body may comprises a portion of an implantable surgical device. An oxide free phosphorus-containing layer is on the metal surface, and a hydroxyapatite film is on the phosphate layer. In various embodiments the body may comprise stainless steel or titanium. The oxide-free phosphorus-containing layer may comprises bisphosphonate, possibly formed from etidronic acid. The oxide free phosphorus-containing layer may have a thickness of less than about 10 nanometers.

The invention of the present disclosure, in another aspect thereof, comprises a method including providing a metal surface, removing substantially all oxidation from the metal surface, applying a phosphorous layer to the oxide-free metal surface, and applying a hydroxyapatite layer to the phosphorous layer. Removing substantially all oxidation from the metal surface may comprise laser etching the metal surface, or argon-ion etching the metal surface. Removing substantially all oxidation from the metal surface comprises could also comprise abrading the surface while immersed in a solution of deoxygenated acid.

Applying of the phosphorous layer may comprise applying etidronic acid to the oxidation-free metal surface. Applying the hydroxyapatite layer may comprise exposing the phosphorous layer to a saturated solution of hydroxyapatite. The hydroxyapatite layer may comprises a thin film of hydroxyapatite.

### BRIEF DESCRIPTION OF THE DRAWINGS

FIGS. 1A-D shows a flowchart from metal oxide to oxide free portion of metal with an adhering hydroxyapatite coating and a thin oxide free phosphorus coating film substantially therebetween.

FIG. 2 is graph of the valence band spectrum of hydroxyapatite.

FIG. 3 is a graph of an x-ray photoelectron spectroscopy study of hydroxyapatite applied to stainless steel.

### DETAILED DESCRIPTION OF THE PREFERRED EMBODIMENTS

Detailed descriptions of the exemplary embodiments are provided herein. It is to be understood, however, that the invention embodied by the claims may take various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the invention embodied by the claims in virtually any appropriately detailed system, structure or manner. The exemplary figures are not drawn to scale.

Plasma spraying is one method of mechanically applying hydroxyapatite coatings to metallic implants. However, hydroxyapatite will not normally adhere to the metallic surface in any meaningful quantity. Nearly all metals have an air formed surface film of oxide (with one notable exception being gold), which serves to inhibit the attachment of the hydroxyapatite.

Most stable metal salts are water soluble. However, phosphates are generally water insoluble. In accordance with the present disclosure, thin oxide-free phosphate films that have corrosion inhibition properties can be formed on metal surfaces. When the oxide free film is first applied to a bare metal surface, hydroxyapatite coating of the metal can be effected. The hydroxyapatite coating can used for, without limitation, corrosion inhibition, adhesion promotion, or biocompatibility for surface of medical implants.

In one embodiment, adhesion of the hydroxyapatite film to the metal may be facilitated by the initial formation of a thin oxide-free phosphorus containing film (e.g., a bisphosphonate containing film) on the metal. Hydroxyapatite films can be successfully adhered to metal, such a stainless steel and titanium, by first covering the metal surface with a thin oxide free film of etidronate.

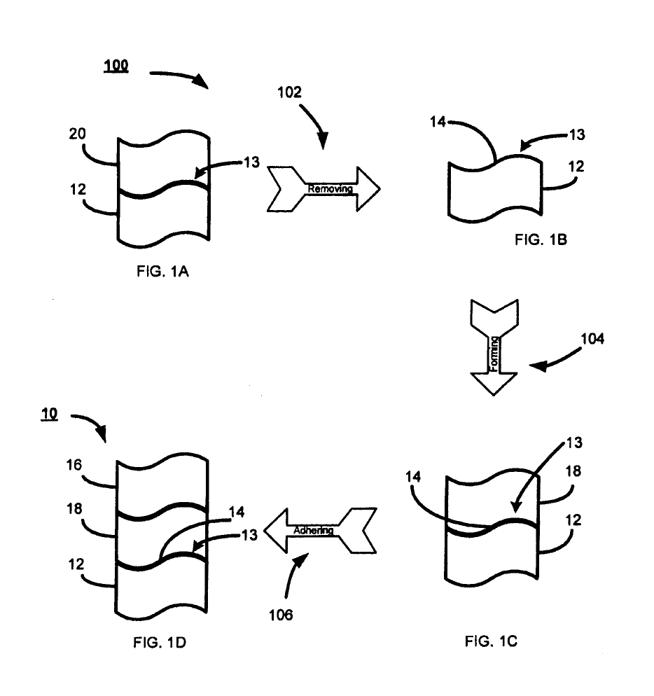

FIG. 1D (not to scale) illustrates a side cutaway of a portion of a device 10 coated as described. A metallic body 12 has a metal surface 13, coated on at least a portion thereof with an oxide-free coating 14. A hydroxyapatite coating 16 attaches to the device metallic body 12 via the oxide-free coating 14.

It is understood that the metallic body 12 may be a portion of an implant or other device, and may be a curved or relatively flat surface depending upon application. The implantable device may be biocompatible for human implantation. Exemplary implantable devices include: an acetabular cup of an implantable, artificial hip joint; an acetabular ring of an implantable, artificial hip joint; an acetabular cage of an implantable, artificial hip joint; a cement-less hip stem of an implantable, artificial hip joint; a humeral stem of an implantable, artificial elbow; an ulnar stem of an implantable, artificial elbow; a femoral cup of an implantable, artificial knee joint; a tibial cap of an implantable, artificial knee joint; a humeral stem of an implantable, artificial shoulder joint; a glenoid component of an artificial shoulder joint; an artificial ankle joint; a dental implant; and a fastener for attaching an implantable artificial joint to bone tissue.

In various embodiments the metal surface 13 may be stainless steel (e.g., 316L) or titanium. In other embodiments the metal may be selected from the first and second rows of transition metals from the periodic table (e.g., Sc, Ti, V, Cr, Mn, Fe, Co, Ni, Cu, Zn, Y, Zr, Nb, Mo, Tc, Ru, Rh, Pd, Ag and Cd), the rare earth metals (e.g., La, Ce, Pr, Nd, Pm, Sm, Eu, Gd, Tb, Dy, Ho, Er, Tm, Yb and Lu), Hf, Ta, W and Re, and the metals of Group III (e.g., Al, Ga, In and Ti).

In one embodiment the oxide free-coating 18 comprises oxide-free phosphorus. In some embodiments, the oxide-free film 18 will be a thin film. In the present embodiment, a thin film may be considered a film having a thickness of approximately 10 nanometers or less. In such embodiments, where the film 18 is a thin film it may be less likely to fracture as might a thicker film due to bending or temperature changes. In addition, the thin film 18 displays chemical properties that reflect the surface of the material forming the film 18. The surface chemistry and physical behavior of the surface regions are often different from that of the bulk. In particular, surfaces may have chemical functionality which can undertake surface chemical reactions that are different from the bulk material. It is this property that often gives nanomaterials their unique properties.

When the hydroxyapatite coating 16 is thin it enables X-ray photoelectron spectroscopy to probe the interface of the hydroxyapatite coating 16 and the oxide free phosphorus containing film 18. However, the hydroxyapatite coating 16 thickness may be limited by the body 12 thickness, e.g., the hydroxyapatite coating 16 has been prepared as thick as 2 millimeters (“mm”) when the body 12 is 0.2 mm.

Where the oxide-free film 18 comprises phosphorous, the phosphorus may be in the form of an organophosphorus acid, such as a bisphosphonate. Representative bisphosphonates include etidronate (Didronel), pamidronate (Aredia), alendronate (Fosamax), risedronate (Actonel), zoledronate (Zometa or Reclast), and ibandronate (Boniva). In another embodiment the bisphosphonate is etidronic acid. Etidronic acid is 1-hydroxyethane 1,1-diphosphonic acid or hydroxyl-ethyl disphosphonate (HEDP). In some embodiments, the CH₃ group of etidronic acid may be replaced with longer chain alkyl groups.

Bisphosphonates have been used for a number of years as a treatment for the prevention of bone loss. In these bone loss prevention applications, water-soluble bisphosphonates have been given to patients with the goal of targeting the bone which interacts with the soluble bisphosphonates. These medical applications indicate that the variation of the alkyl group is one way of changing the level of interaction with hydroxyapatite.

The hydroxyapatite coating 16 adherent to the metal body 12 via the thin film 18 is resistant to corrosion by exposure to water, air or sodium chloride solution. In various embodiments, the hydroxyapatite coating 16 resists corrosion for at least 2 hours in water or 1M sodium chloride and at least 50 days in air.

In one embodiment, the oxide free phosphorous film 18 is disposed substantially between the oxide free metal surface 13 and the hydroxyapatite coating 16 to provide inhibition of corrosion by body fluids, adhesion promotion and biocompatibility for implantable devices. The hydroxyapatite film 16 also protects the body 12 from undesirable compounds generated by the corrosion process (e.g., chromate ions from chromium in stainless steel).

Producing or preparing the body the body 12 with to have a metal surface 13 with an oxide free portion 14 can be performed by using an anaerobic cell or a “bench” treatment. The terms “bench” and “benchtop” treatment refer herein to a process where the metal surface 13 is abraded while immersed in a deoxygenated solution of an acid. The anaerobic cell is described in the U.S. Pat. No. 6,066,403 to Sherwood et al. and the “bench” treatment is described in Yu-Qing Wang and P. M. A. Sherwood, Interfacial Interactions of Polymer Coatings onto Oxide-free Phosphate Films on Metal Surfaces, Journal of Vacuum Science and Technology A, 21, 1120-1125 (2003), both of which are hereby incorporated by reference.

Referring again to FIGS. 1A-1D the flowchart 100 indicates that in one embodiment, the process for assembly begins with the body 12 that includes a metal surface 13 having an oxide layer 20. At step 102 the oxide layer 20 is removed (e.g., by laser etching or argon-ion etching in the anaerobic cell, or the “bench” treatment) and this yields the metal surface 13 having at least an oxide free portion 14, as seen in FIG. 1B.

At step 104, forming a layer of oxide-free phosphorous 18 on the oxide free portion 14 can be accomplished by treatment of the metal surface 13 with a solution of etidronic acid. FIG. 1C illustrates the thin film layer 18 in place on the oxide-free layer 14. For example, treating the “bench” treatment of 316L stainless steel with a 3M solution of etidronic acid forms a thin oxide free etidronate film 18 on stainless steel 12. In an alternative embodiment, titanium is treated with a 3M solution of etidronic acid to form the thin oxide free etidronate film 18 on titanium 12. In other embodiments, a bisphosphonate other than etidronic acid may be utilized. In further embodiments, another organophosphorus may be used for forming the layer of oxide free phosphorous 18.

Process step 106 comprises adhering a hydroxyapatite layer 16. In some embodiments, this is accomplished by exposing the layer 18 to a solution of hydroxyapatite to produce the hydroxyapatite coating 16 (FIG. 1D). In one embodiment, the step 106 of exposing the layer 18 includes at least a 20 minute exposure of the film 18 to a saturated solution of hydroxyapatite (e.g., 100 parts per million) that yields an observable white hydroxyapatite film 16. X-ray photoelectron spectroscopy (“XPS”) studies may be utilized to confirm that the film 16 is hydroxyapatite if desired.

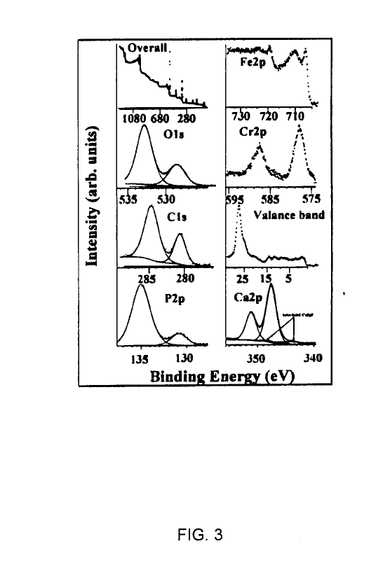

Thick hydroxyapatite films 16 show an XPS spectrum identical to that of hydroxyapatite. Thin hydroxyapatite films 16 show a spectrum that consists of the hydroxyapatite and the underlying etidronate 18 and features from the steel substrate 14. These thin films (16, 18) may show differential charging effects that cause a doubling of the peaks (see FIG. 3).

Differential charging is an experimental approach, first reported in 1973 [T. Dickinson, A. F. Povey and P. M. A. Sherwood, J. Electron Spectrosc. Related Phenom. 2, 441 (1973)] which can be used to further probe surface chemical differences by exploiting different physical and chemical properties of surface species that cause them to behave differently when exposed to a sample electrical bias (see P. M. A. Sherwood, J. Electron Spectrosc. Related Phenom. 176, 2 (2010)). In this work differential sample charging proved a valuable method for learning more about the surface chemistry of these unusual films.

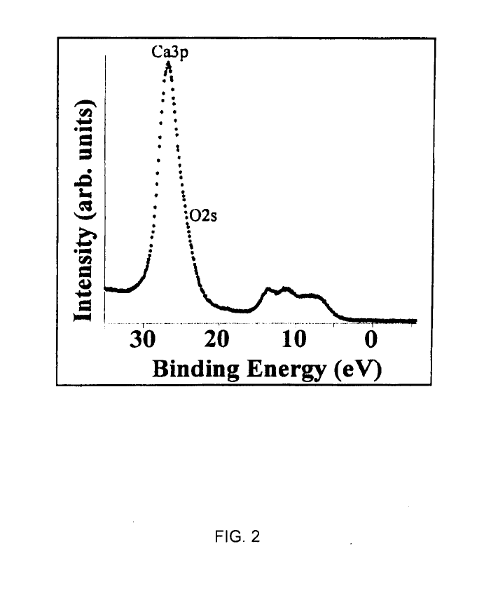

The separation of the peaks arising from differential sample charging increases as the hydroxyapatite film 16 thickness increases, until only hydroxyapatite can be detected when a single peek is seen (e.g., FIG. 2). There are spectral features that probably arise from the interface region which suggests that there are chemical interactions at the interface.

Removing the oxide layer 20, followed by forming the etidronate film 18 then the adhering the hydroxyapatite film to titanium leads to peak doublets in the core level by XPS. Peak separation varied from zero eV in fixed samples whose spectra were identical to hydroxyapatite to 6.1 eV for very thin samples that showed features due to etidronate 18 and the substrate metal 12. The thinner the film 18 the greater the peak separation.

On the other hand, hydroxyapatite does not readily adhere to metals. For example, the 20 minute exposure of a body 12 of stainless steel (e.g., 316L) to the saturated solution of hydroxyapatite at 100 ppm using the “bench” treatment leads to no observable hydroxyapatite film on the body 12. In addition, XPS studies confirm there is no change on the surface 13 of the body 12 after treatment with the saturated solution of hydroxyapatite.

While the invention has been described in connection with an exemplary embodiment, it is not intended to limit the scope of the invention to the particular form set forth, but on the contrary, it is intended to cover such alternatives, modifications, and equivalents as may be included within the spirit and scope of the invention as defined by the appended claims.

The attached appendix provides additional disclosure related to Applicant's inventive concept.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. An device comprising:
a body with a metal surface having an oxide free portion;
an oxide free phosphorus-containing layer on the metal surface; and
a hydroxyapatite film on the phosphorus-containing layer.

2. The device of claim 1, wherein the body comprises stainless steel.

3. The device of claim 1, wherein the body comprises titanium.

4. The apparatus of claim 3, wherein the oxide-free phosphorus-containing layer comprises bisphorphorous.

5. The apparatus of claim 4, wherein the bisphosphonate is formed from etidronic acid.

6. The apparatus of claim 1, wherein the oxide free phosphorus-containing layer has a thickness of less than about 10 nanometers.

7. The device of claim 1, wherein the body comprises a portion of an implantable surgical device.

8. A device comprising:
at least a portion of a medical device implant, the medical device implant having a metallic surface;
an oxide free layer formed on the metallic surface;
a phosphorous containing layer applied to the oxide-free layer; and
a hydroxyapatite layer applied to the phosphorous containing layer;
wherein the hydroxyapatite layer has a maximum thickness over at least a portion thereof such that chemical reactions occurring at a surface thereof are reflective of at least the metallic surface of the phosphorous containing layer.

9. The device of claim 8, wherein the metallic surface comprises stainless steel.

10. The device of claim 8, wherein the metallic surface comprises titanium.

11. The device of claim 8, wherein phosphorous containing layer comprises bisphosphorous.

12. The device of claim 8, wherein the phosphorous containing layer comprises an organophosphate.

13. A method comprising:
providing a metal surface;
removing substantially all oxidation from the metal surface;
applying a phosphorous layer to the oxide-free metal surface; and
applying a hydroxyapatite layer to the phosphorous layer.

14. The method of claim 13, wherein removing substantially all oxidation from the metal surface comprises laser etching the metal surface.

15. The method of claim 13, wherein removing substantially all oxidation from the metal surface comprises argon-ion etching.

16. The method of claim 13, wherein removing substantially all oxidation from the metal surface comprises abrading the surface while immersed in a solution of deoxygenated acid.

17. The method of claim 13, wherein applying a phosphorous layer comprises applying etidronic acid to the oxidation-free metal surface.

18. The method of claim 13, wherein applying a hydroxyapatite layer comprises exposing the phosphorous layer to a saturated solution of hydroxyapatite.

19. The method of claim 13, wherein applying a hydroxyapatite layer comprises applying a thin film of hydroxyapatite.
